(19) United States
(12) Patent Application Publication
(10) Pub. No.: US 2005/0050943 A1
(43) Pub. Date: Mar. 10, 2005

(54) Dry aerosol leak detection for dialyzers

(76) Inventors: Tom Barber, Salem, WI (US); Jim Lenart, Barrington, IL (US); Neal Zupec, Spring Grove, IL (US)

Correspondence Address: BAXTER HEALTHCARE CORPORATION;RENAL DIVISION, 1 BAXTER PARKWAY, DF3-3E, DEERFIELD, IL, 60015, US

(21) Appl. No.: 10/657,407

(22) Filed: Sep. 8, 2003

(51) Int. Cl. G01M 3/04

(52) U.S. Cl. 73/40.7

(57) ABSTRACT

The present invention provides a leak testing method and system therefore for any type of filtering device employing hollow fibers, such as filtration of aqueous or gaseous fluids, ultrafiltration of particulate materials and dialysis of blood. In an embodiment, the leak test is employed in testing a bundle of fibers placed in a dialyzer. The dialyzer includes a blood inlet and a blood outlet, wherein blood flows through the inside of a plurality of hollow fibers. Dialysate flows into the dialyzer through an inlet port, around the outside of the hollow fibers and out of the dialyzer through an outlet port. The test employs a dry aerosol that is injected into the blood inlet, outlet or both, wherein a particle counter counts particles that pass through the fiber walls and exit one or both the dialysate ports. If the counter detects more than an acceptable amount of particles, the dialyzer has a leak.

### BACKGROUND OF THE INVENTION

This invention relates generally to the field of medical devices. More particularly the present invention relates to a method for testing medical devices.

It is known to provide dialysis to treat kidney failure. To this end, different methods of providing dialysis have been developed. One type of dialysis is hemodialysis, which removes waste from a patient's blood. Hemodialysis is performed using machines that include typically an extracorporeal blood circuit. The blood circuit includes an arterial line, a blood pump, a dialyzer and a venous line. The patient is connected to the arterial and venous lines via a catheter inserted into the patient's vein or artery. The blood pump removes blood from the patient and pumps same through the arterial line to an inlet or blood side of the membrane in the dialyzer. The dialyzer includes typically a semipermeable membrane that separates waste components, such as proteins, toxins and excess water from the patient's blood.

A separate pump is provided that pumps dialysate through a dialysate side of the membrane of the dialyzer. The waste components flow from the blood across the membrane to the dialysate. A large amount of dialysate, for example about one hundred twenty liters, is used to dialyze the blood during a single hemodialysis therapy. The membrane is designed to prevent waste components from flowing from the dialysate back to the patient's blood. The blood pump returns the blood from the dialyzer to the patient via the venous line. The spent dialysate is then discarded. Hemodialysis treatment lasts several hours and is performed generally in a treatment center about three or four times per week.

The dialyzer membranes often consist of a bundle of microporous hollow fibers arranged in a housing. The fibers have walls that define multiple pores through which proteins, toxins, excess water and dialysate can pass but through which red blood cells and other desirable blood components cannot pass. The fibers are sealed to the housing at inlet and outlet ends by potting or filling the interstices between the bundled fibers at the ends with a polymer or resin. The potted ends are created by capping off the ends, injecting liquefied polymer or resin into the housing and spinning the housing so that the liquefied sealant gravitates due to centripetal force towards the capped ends. Afterward, the sealant dries with the polymer or resin sealed around the outside of the fibers. The assembly is then flush cut at the ends so that the fibers are open along outer surfaces of the housing. Blood enters the fibers at one of the surfaces, flows through the hollow fibers and out the opposing surface.

Defects or leaks may form in the bundled fiber assembly in a number of places and for a number of reasons. For instance, during the spinning of the hollow fibers, the liquefied polymer or resin may not fully or adequately flow or seal around the tightly packed bundle of fibers. Voids and cavities can also form resulting in short-paths of blood that circumvents the pores of the hollow fibers. In these cases, the potting is faulty. Additionally and for various reasons, such as during shipping or during the spinning process, pinholes or fissures may form inadvertently in the porous fiber walls. Dialyzers and in particular the fibers must be tested before the dialyzers are used in therapy.

One known dialyzer test employs a time consuming “wet” test method. This test immerses the dialyzer in water, pressurizes the dialyzer and records the airflow across the fibers. Afterwards, the dialyzer must be dried. Drying the dialyzer is time consuming. With the demand for hemodialysis dialyzers increasing, the wet test becomes a bottleneck, preventing optimal production.

Also, the wet test yields a good or bad result but does not disclose the source or location of the leak. It is possible to repair a leaking dialyzer if the source or location of the leak is known. The wet test does not lend itself to dialyzer repair.

A need exists therefore to provide a dialyzer leak test that is performed more quickly than the wet leak test. A need also exists to provide a leak test that yields the source or location of a leak. The test also needs to be as accurate or more accurate than the wet test.

### SUMMARY OF THE INVENTION

The present invention provides a leak test for any type of filtering device employing hollow fibers. Hollow fibers are used for various purposes such as filtration of aqueous or gaseous fluids, ultrafiltration of particulate materials and dialysis of blood. In an embodiment, the leak test is employed in testing a bundle of fibers placed in a dialyzer. With dialyzers, leakage occurs when one or more openings appears in the hollow fiber walls or potted ends that allow red blood cell to pass from the dialyzer fibers. Red blood cells are about seven microns in diameter. The pores defined at the inner surface of the wall of a fiber are about twenty nanometers to about one hundred nanometers in diameter. Red blood cells, by orders of magnitude, cannot pass through the fiber walls unless the fiber wall is torn or otherwise leaking.

The dialyzer includes a blood inlet and a blood outlet, wherein blood flows through the inside of the hollow fibers of a bundle of hollow fibers. Dialysate flows into the dialyzer through an inlet port, around the outside of the hollow fibers and out of the dialyzer through an outlet port. The system and method of the present invention employ a dry aerosol that is injected into the blood inlet, outlet or both, wherein a particle counter is employed to count particles that pass through the fiber walls and exit one or both the dialysate ports. If more than an acceptable amount of particles is detected, the dialyzer is determined to have a leak.

The dry aerosol particles have diameters or widths of about thirty nanometers to about two microns in size. Some of the smallest particles may therefore be able to pass through the larger pores of the fiber walls. The method tests for an abnormal or unacceptable amount of particles, the occurrence of which renders the dialyzer a reject.

Most particles remain inside the hollow fibers and in the case of acceptable dialyzers can pass eventually into the patient's blood stream. In an embodiment, the particles are sodium chloride and are therefore safe physiologically to enter the patient's blood stream. The mass of particles remaining inside the dialyzer after the test is small so that the effects of salt from a tested dialyzer entering the patient's blood stream are negligible.

The salt particles are created from a solution of salt in water in an embodiment. The particles are generated in different sizes, wherein each of the particles regardless of size is used to test the dialyzer. The particles could alternatively be filtered so that a desired mono-size particle is used. The use of different size particles, i.e., polydisperse particles, is advantageous because the particulate matter used to create the particles is used more efficiently. Further, the use of the full range of particles enables the test to be performed more quickly than if a limited number of mono-size particles is used.

The system and method of the present invention enable the average size of the particles to be varied by varying the pressure, flowrate and concentration of particles in solution. The average size of the particles can be controlled therefore as can the average number of particles produced. This flexibility allows different size particles and different densities of particles to be created for different tests, i.e., for different hollow fibers or for different leak sizes in a single fiber.

The system flows wet particles into a mixing chamber that mixes the wet particles with hot, dry air, drying the particles. The dry particles then flow into the dialyzer using multiple flow paths so that the dialyzer can be tested sequentially via the different flow paths, and wherein different areas of the dialyzer can be tested so as to test thoroughly known leakage points, e.g., near the potted ends. The system and method also determine the portion of the fiber bundle that is leaking, so that the damaged dialyzer can be repaired and used.

It is therefore an advantage of the present invention to provide a dialyzer leak test having a fast response time.

It is another advantage of the present invention to provide a dialyzer leak test that points to a source or location of a leak.

It is a further advantage of the present invention to provide a dialyzer leak test that uses a polydisperse aerosol to minimize particle loss.

Further still, it is an advantage of the present invention to use multiple pressure and particle concentration reducing steps in the test aerosol flow path to adjust the aerosol to the size of leak that needs to be detected.

It is still another advantage of the present invention to provide a dialyzer leak test that uses a relatively high flowrate to reduce particle loss and increase particle detection.

Moreover, it is an advantage of the present invention to provide a dialyzer leak test having several testing paths on one unit to reduce particle losses and increase the probability of detecting fiber or potted end defects at low leak rates.

It is yet another advantage of the present invention to provide a dialyzer leak test that applies sequential testing principles per ISO 14644-1 or IEST 209-E and variable test intervals to match the size of leaks to be detected (i.e., smaller leaks require larger test intervals).

Additional features and advantages of the present invention are described in, and will be apparent from, the following Detailed Description of the Invention and the figures.

### BRIEF DESCRIPTION OF THE FIGURES

FIG. 1 is a perspective view of a dialyzer, which is one type of device employing hollow fibers that can be tested via the system and method of the present invention.

FIG. 2 is a magnified view of one of the end caps of the dialyzer illustrated in FIG. 1.

FIG. 3 is a magnified view of a hollow fiber tested by the system and method of the present invention.

FIG. 4 is a magnified view of the interior surface of the hollow fiber illustrated in FIG. 3.

FIG. 5 is a magnified view of the exterior surface of the hollow fiber illustrated in FIG. 3.

FIG. 6 is a schematic process flow diagram illustrating the system and method of leak testing microporous fibers of the present invention.

FIGS. 7 and 8 are perspective views illustrating the equipment of one embodiment of the system of the present invention.

FIGS. 9A and 9B are schematic views of one of the counters of the present invention showing the difference in counts (e.g., particles/cm³) between a leaking and non-leaking dialyzer.

FIG. 10 is a magnified view of an interior surface of a hollow fiber tested according to the system and method of the present invention showing remaining residual physiologically safe particles.

### DETAILED DESCRIPTION OF THE INVENTION

The present invention provides a system and method for testing the integrity of hollow fibers placed inside of a device. The device is any type of device used for filtering or cleaning that employs hollow, multi-porous fibers, such as devices for the filtration of aqueous and gaseous fluids, ultrafiltration of particles and the dialysis of blood. Although the present invention will be described in connection with a dialyzer for blood dialysis, it is expressly contemplated that the system and method described herein can be used with equal effectiveness in these other applications.

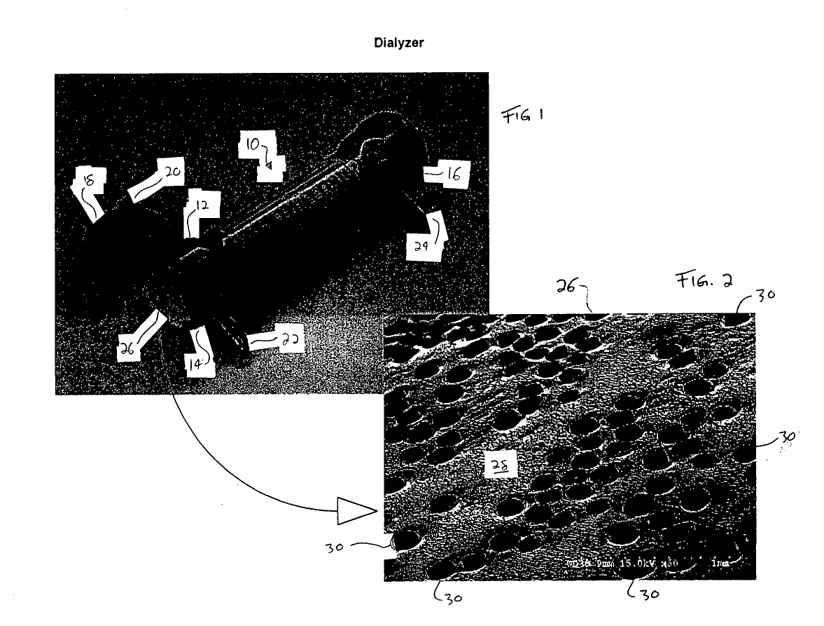

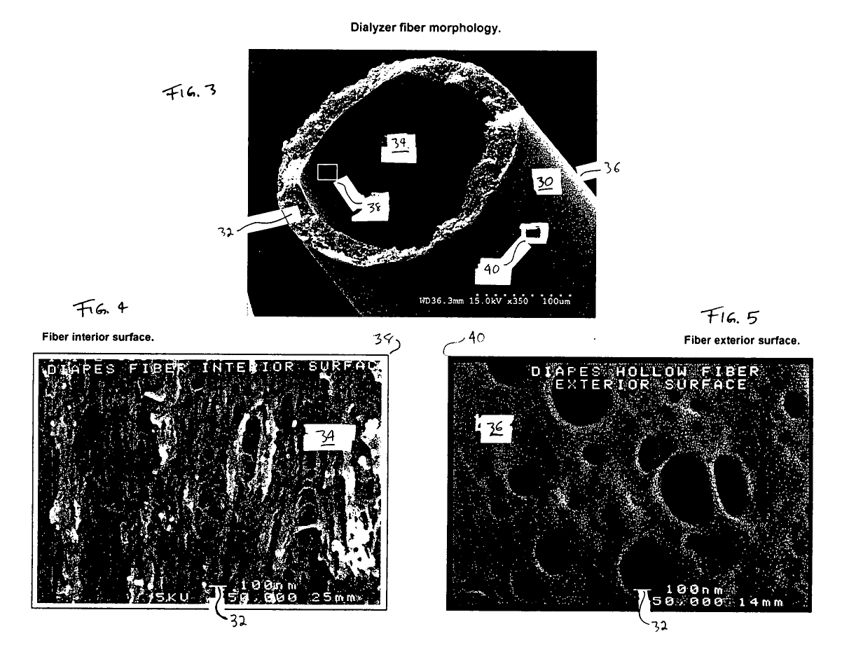

Referring now to the figures and in particular to FIGS. 1 and 2, a dialyzer 10 is illustrated. Dialyzer 10 includes a clear or translucent plastic housing 12. Housing 12 defines open ends 14 and 16. As described in more detail below, each of the ends 14 and 16 is potted with a polymer or resin material that seals the interstices between the fibers and the space between the outside of the hollow fibers and the inner-wall of housing 12 at ends 14 and 16.

Dialyzer 10 also includes a pair of end caps 18 that thread onto threads defined by potted ends 14 and 16 or otherwise seal two ends 14 and 16 via methods known to those of skill in the art. End caps 18 each define a blood port 20. Blood port 20 connects to a tube for transporting blood from or to a patient and defines a tapered end, hose barb, threads or other structure known to those of skill in the art for connecting a tube sealingly to the blood port 20.

Near the potted ends 14 and 16, dialyzer 10 defines dialysate ports 22 and 24. The ports allow respectively dialysate to flow into and out of housing 12. While inside the housing 12, the dialysate flows around the outside of the hollow porous fibers bundled inside housing 12. Ports 22 and 24 include the tapered ends, hose barbs, threads or other apparatuses for connecting sealingly to tubes that run to and from a source of dialysate.

Potted ends 14 and 16 are created in one instance by pouring polyurethane in a liquefied state into dialysate ports 22 and 24 after the bundle of porous fibers have been placed inside housing 12. While the polyurethane is still in its liquid state, the dialyzer 10 is spun about an axis extending through the center of housing 12, so that the liquid polymer gravitates outwardly due to a centripetal force produced by the spinning. Ends 14 and 16 are capped temporarily so that the liquefied polymer or resin flows against the temporary caps, forcing the liquid into the interstices between the hollow fibers and between the inner surface of housing 12 and the hollow fibers residing along the circular edge of ends 14 and 16.

When the polymer or resin dries and hardens, it seals the ends as illustrated in the magnified FIG. 2. FIG. 2 illustrates a rectangular magnified section 26 shown in FIG. 1 on the surface of potted end 14. The polymer or polyurethane 28 is illustrated as having hardened between the hollow fibers 30. FIG. 2 illustrates the very end of dialyzer 10, where blood would flow from or to one of the caps 18 into or from respectively the hollow fibers 30.

The solidified polymer or resin of potted ends 14 and 16 prevents dialysate flowing into port 22 or 24 from flowing out the ends 14 and 16. The potted ends 14 and 16 also prevent blood from entering into the area of dialysate flow within housing 12 by circumventing the restrictions applied by the hollow fibers 30.

The method of producing potted ends 14 and 16 provides one area of potential leakage. If the polymer does not flow properly between the fibers, if the fibers are bunched together so that the flow cannot properly fill voids between the fibers or if for any other reason voids or cavities are formed in the polymer, a leak can form.

Referring now to FIGS. 3 to 5, a magnified view of an end of one of the microporous hollow fibers 30 is illustrated. The inner diameter of one commonly used hollow fiber 30 is about two hundred microns. The diameter or width of a red blood cell, which is not removed from the blood flow during dialysis is about seven microns. The hollow fiber 30 is defined by wall 32 having an inner surface 34 and an outer surface 36. Wall 32 is formed using a chemical or other known process to produce multiple pores that allow certain blood components to travel from the inside of wall 32 of fiber 30 to the outside of wall 32 of fiber 30 and vice versa.

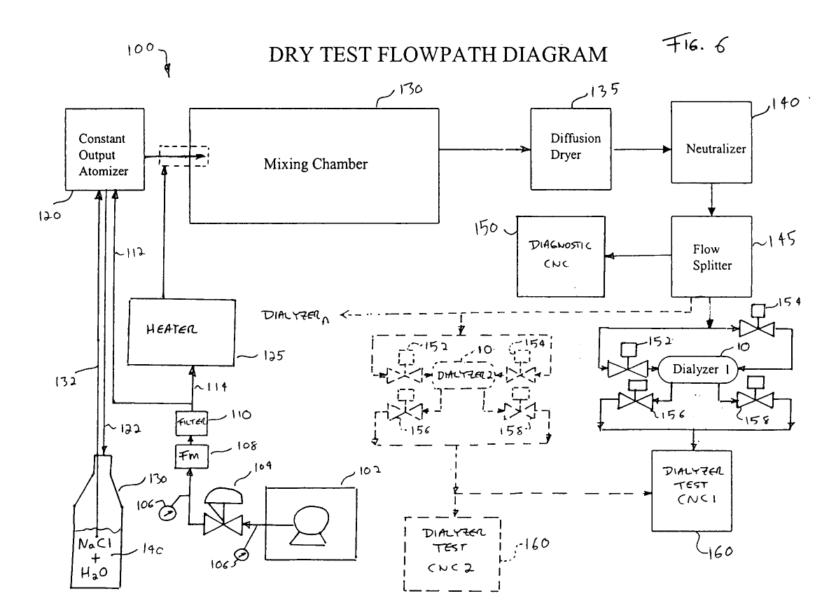

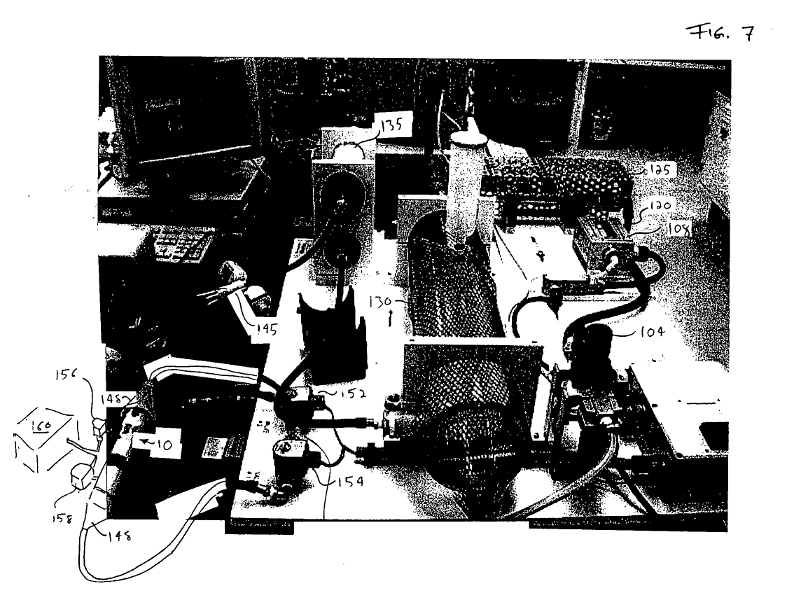

FIGS. 4 and 5, respectively, are magnified views of sections 38 and 40 taken at inner surface 34 and outer surface 36, respectively. Section 38 of FIG. 4 illustrates a magnified view of the pore morphology of the inner surface 34 of wall 32. A line 33 marks a distance of 100 nanometers. The pores formed on inner surface 34 of wall 32 are as seen about five to about one hundred nanometers in diameter or width.

Section 40 of FIG. 5 illustrates a magnified view of outer surface 36 of wall 32 of fiber 30. Line 33 marks again a distance of 100 nanometers. Section 40 therefore illustrates that the pores on outer surface 36 of wall 32 are larger than the pores on inner surface 34 of wall 32. This is due to the chemical or other process that forms the microporous walls 32.

The smaller size pores on inner surface 34 are substantially smaller than, for instance, red blood cells and other components of blood that are desirable and are not filtered. Proteins, toxins and other waste products, however, are able to pass from the smaller pores on the inner surface 34 to the outside of the fiber 30, wherein dialysate carries the toxins away.

Due to: (i) handling; (ii) the process of bundling the fibers 30; (iii) the process of placing the bundled fibers within housing 12 of dialyzer 10; (iv) the process of potting ends 14 and 16; and (v) other causes, the walls 32 of the fibers 30 can become torn, yielding openings orders of magnitude bigger than the pores illustrated in FIGS. 4 and 5. When this happens, desirable blood components flow through the tear into the surrounding dialysate. Also, the slightly positive pressure of the blood pumped inside the walls 32 during dialysis, which prevents the waste and toxins from reentering the flow of blood, becomes corrupted so that the blood cleaning process is not performed properly. It is therefore mandatory that the fibers 30 and the dialyzer 10 housing same are tested prior to use in therapy with a patient.

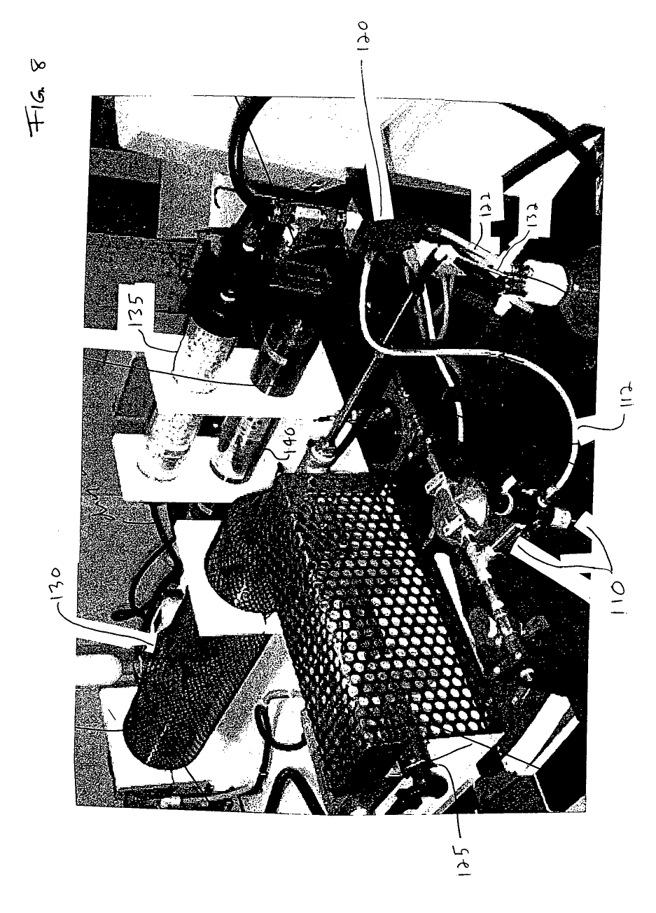

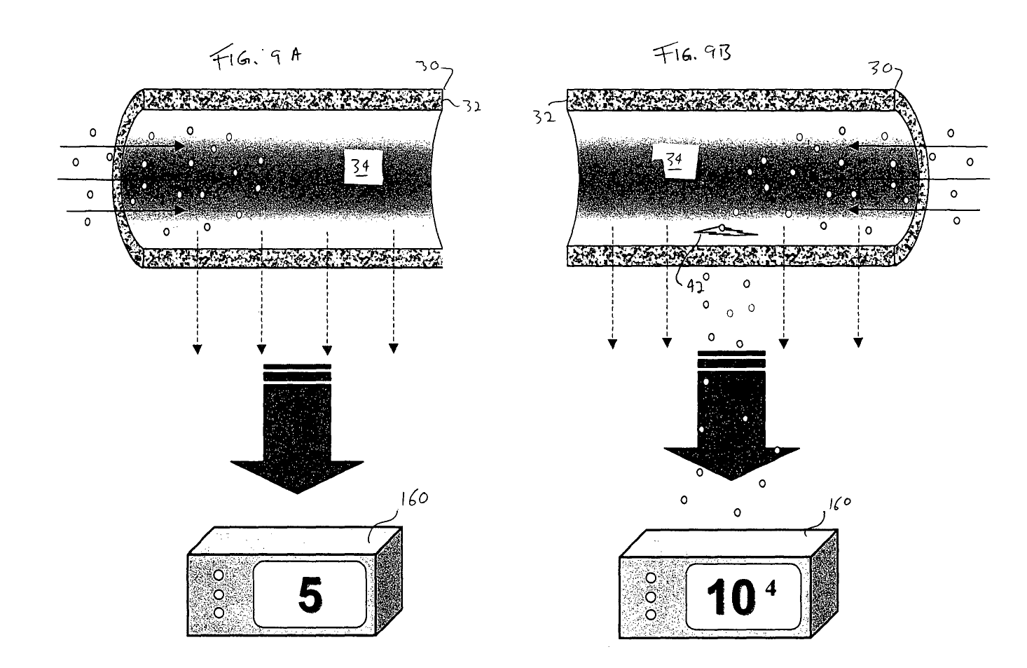

Referring now to FIGS. 6 to 8, a system 100 and method therefore of the present invention for testing the hollow fibers 30 are illustrated. FIG. 6 illustrates a schematic layout of the components of the system 100 in a process flow sequence, so that the corresponding method is described simultaneously. FIG. 6 also illustrates that a plurality of dialyzers 10 can be tested at one time, for example, in a manufacturing environment. FIGS. 7 and 8 illustrate various views of the actual components that have been assembled in a laboratory environment to test and verify the operation and results of the system 100 and method of using same.

As illustrated in FIG. 6, system 100 includes a source of pressuring a fluid or gas. In the schematic illustration of FIG. 6, the pressure source is a compressor 102, which compresses air. Compressed air provides one economical and chemically suitable fluid for use with the system 100 of the present invention. It should be appreciated however that other sources of compressed fluid or vapor, such as compressed nitrogen, argon, carbon dioxide or any combination of these, could be used instead. In such cases, the vapor can be produced by vaporizing and pressurizing a liquefied gas or from pressurized cylinders storing the vapor. In the laboratory setup of FIGS. 7 and 8, the gas used was house processed air.

The system 100 includes a pressure reducing regulator 104 to reduce the pressure of the compressed gas to a desired and steady level. One or more pressure gauges 106 split off of the flow line to static lines to measure and indicate the pressure before and after the pressure reducing regulator 104. The remainder of the system 100 will be described using air, however, it should be appreciated that any of the above-mentioned gases can be used.

After regulator 104, the air passes through a flow meter 108, which measures and displays the flowrate of air used in system 100. In one embodiment, the pressure is reduced from compressor 102 to about 10 psig and the flowrate of air is controlled via one or more valves, such as needle valves (not illustrated) to about six to eight liters per second. Flow meter 108 is illustrated additionally in FIG. 7. The flow meter is equipped with a needle or throttling valve to control the flowrate in an embodiment. Otherwise, one or more separate flow control valves, including self-controlling valves with pneumatic or electronic feedback is used.

FIGS. 6 and 8 illustrate that after the flow meter, the air travels through one or more filters 110. FIG. 8 illustrates the use of two air filters 110. The filters remove impurities from the air or gas that could otherwise cause undesirable particles to enter the dialyzer 10. As seen most readily in FIG. 6, the air flow splits, wherein one flow path 112 leads to an atomizer 120, while another flow path 114 leads to a heater 125.

Atomizer 120 in an embodiment is a constant output atomizer. The atomizer 120 as discussed below creates a desired aerosol flow. Such atomizers are well known to those of skill in the art. Atomizer 120 is connected fluidly to a receptacle 105 via a pressurized line 116 that extends from the atomizer 120 to the receptacle 105. Pressurized air extends along path 112, through atomizer 120 and into receptacle 105. A second line 118 extends into a solution 115 held by receptacle 105. The air from pressurized line 116 applies pressure to the surface of the solution 115, wherein solution 115 is pushed up through fluid line 118 into atomizer 120.

The solution 115 in one preferred embodiment is NaCl dissolved in water. In other embodiments, solution 115 can include other physiologically safe materials. Salt is a desirable particulate matter for the present invention because it is safe physiologically and is relatively inexpensive. The concentration of salt in the solution 115 is one important factor for controlling the method of system 100 to achieve a desired result, i.e., desired particle sizes and densities.

When the solution travels up the fluid line 118 and into atomizer 120, the atomizer impacts the solution with a burst of fluid or air, splitting the solution into a spray of droplets. The droplets are individual salt crystals housed inside a shell of liquid water in an embodiment. The concentration of salt in solution 115 determines at least in part: (i) the average size of the crystals as well as (ii) the number of droplets created per a given volume. It is desirable in one aspect to have smaller salt particles because smaller salt particles are better able to remain entrained within an air stream and travel all the way through the flow path of system 100, through the dialyzer 10 and potentially through a leak of a fiber 30 therein to a particle counter. For this reason, it is desirable to maintain the concentration at a lower level. In another aspect, it is also desirable to have more rather than less particles entrained in the air flow. An aerosol having a higher number of particles will be able to deliver a higher number of particles through a leak to the dialyzer 10. The higher number of particles should increase the accuracy of the test as well as the response time of the testing method of the present invention. A balance is therefore struck between setting the concentration to produce smaller particles and to also produce a sufficient number of particles. In one embodiment, the concentration of salt in water is about 0.001 to 99 percent.

In the laboratory configuration illustrated in FIGS. 7 and 8, excellent results were achieved using a concentration of one percent or lower. It should be appreciated however that in a manufacturing setting numerous dialyzers may connect to the same aerosol stream. In such a case, it may be desirable to use salt concentrations above one percent. It is also contemplated to use multiple atomizers 120 in parallel with, for example, a lower concentration solution to produce multiple streams of smaller particles.

As discussed above, the aerosol leaving atomizer 120 includes moisture or liquid from solution 115. To prevent the dialyzers from having to be dried after the testing method of the present invention, it is therefore desirable to use a dry aerosol rather than a wet aerosol. Removing the moisture minimizes the amount of particles trapped by the slightly hydrophobic fibers 30. The aerosol of system 100 passes through at least one drying procedure before entering the dialyzer 10. In the embodiment illustrated in FIG. 6, heated air from heater 125 is combined with the aerosol from atomizer 120 within a mixing chamber 130. Mixing chamber 130 as illustrated in FIGS. 7 and 8 in an embodiment is a section of a larger tube or pipe, which has a wall thickness sufficient to hold the pressurized air. The mixer 130 provides an enclosed space for the heated air from heater 125 and the aerosol from atomizer 120 to mix so that the water or other liquid evaporates from the wet aerosol stream, forming dry particles of salt crystals.

In the lab system of FIGS. 7 and 8, heated air is injected into a third tube that surrounds the tube injecting the aerosol from atomizer 120 into mixing chamber 130. The hot air stream immediately contacts the wet aerosol and mixes with same. It should be appreciated that mixer 130 can be configured in a variety of ways to promote further the mixing of hot air from heater 125 and the aerosol output from atomizer 120, such as providing baffles, a counter flow arrangement wherein the hot air stream is injected directly at and in the opposite direction of the aerosol stream, etc. It is also desirable that chamber 130 allows access to clean residual salt particles from the inner surface of chamber 130.

The dry aerosol exits the mixing chamber 130 and encounters a second drying procedure, e.g., a diffusion or chemical dryer 135. Diffusion dryer 135 is also known in the art as a desicater. The desicater 135 is an air tight chamber containing a drying agent that absorbs moisture. The moisture remaining in the aerosol after the aerosol leaves mixing chamber 130 is removed chemically in the diffusion dryer 135. The aerosol leaving the diffusion dryer 135 is completely dry or substantially dry. It should be appreciated that the system 100 can include alternatively a combination of one or more mixing chambers 130 and one or more chemical dryers 135 or one or more hot air mixer 130 only or one or more diffusion dryer 135 only.

After leaving the diffusion dryer 135, the aerosol passes through a neutralizer 140. The neutralizer 140 strips the aerosol of any static charge that has been built. The static charge tends to make the particles in the aerosol more prone to sticking to the inside surfaces of tubing and the hollow fibers 30. Removing the static charge makes the particles less apt to adhere to the wall 32 of the fiber 30 rather than pass through a leak in the dialyzer 10. If the dialyzer 10 passes the test, it can be purged using compressed air free of particles to blow remaining salt particles through the fibers 30. The salt particles, as illustrated in more detail below in connection with FIG. 10 do not otherwise present a safety hazard to a patient when carried into the patient's bloodstream during therapy.

Upon leaving the neutralizer 140, the aerosol passes through a flow splitter 145 that splits the flow to a diagnostic particle counter 150 and to one or more dialyzers 10. Although a simple right angle tee fitting may be used to split the flow, in one preferred embodiment, a horizontal flow splitter 145 as illustrated in FIG. 7 is used so that the aerosol is not bombarded against a right angled wall of the tee fitting. Furthermore, depending on how many dialyzers are used, a separate flow line and one or more flow splitters can be used for each dialyzer 10 as indicated in FIG. 6. Alternatively, a single perhaps larger split line can feed each of a plurality of dialyzers 10 wherein second flow splitters or tee fittings are positioned after the flow splitter 145 illustrated in FIG. 6.

The diagnostic particle counter 150 ensures that the method of system 100 is being performed properly. Diagnostic particle counter 150 ensures that a desired number of particles are being supplied to the one or more dialyzers 10. In one embodiment, the diagnostic particle counter 150 as well as the one or more test particle counters 160 are condensation nucleus counters or (“CNC's”). CNC-type counters detect particles by first passing the particles over a bed of cooled liquid methanol. The methanol condenses on the particles and increases their size, making the particles easier to detect. The CNC counters 150 and 160 are commercially available as is known to those of skill in the art. One suitable CNC machine counts condensated particles above three nanometers.

One advantage of the present invention is that each of the particles created by atomizer 120 is used regardless of the size of the particle created. Atomizers exist that filter particles of an undesirable size and create a stream of mono-size particles. With mono-size particles, the number of useable particles created is lessened since many of the particles of an undesirable size are discarded. The system 100 of the present invention, however, allows a varying size particle stream or polydisperse stream to be used. This increases the production rate of particles per a given concentration of the particle matter in solution 115. The polydisperse particles are then in essence mono-sized in the CNC due to the methanol condensation. The use of polydisperse particles creates a test method that is efficient, accurate and quick.

The particles leaving flow splitter 145 flow to one or more dialyzers 10. The particles flow into the interior of the fibers 30, i.e., inside of walls 32 of the fibers 30, through the blood port 20 of one of the end caps 18. In an embodiment, one of the ends of the dialyzer 10 is blocked off, wherein the particles flow into the opposing end. In the embodiment illustrated in FIGS. 6 to 8, however, the particle flow is connected to both ends of the dialyzer 10 through solenoids 152 and 154. FIG. 7 also illustrates that the cap 18 illustrated in FIG. 1 is in one embodiment replaced by a conical shaped diffuser 148. Diffuser 148 spreads the flow particles apart so that the particles bombard the entire area of the potted end caps 14 and 16 substantially evenly, so that the particles more evenly enter the fibers 30.

In an embodiment, one or more of the dialyzer ports 22 or 24 can be capped so that the aerosol flows out of dialyzer 10 through the non-capped dialysate port. In the embodiments illustrated in FIGS. 6 to 8, however, both dialysate ports 22 and 24 are placed in fluid communication with a respective solenoid 156, 158. The flow leaving solenoids 156 and 158 is combined into a single line to the test CNC 160.

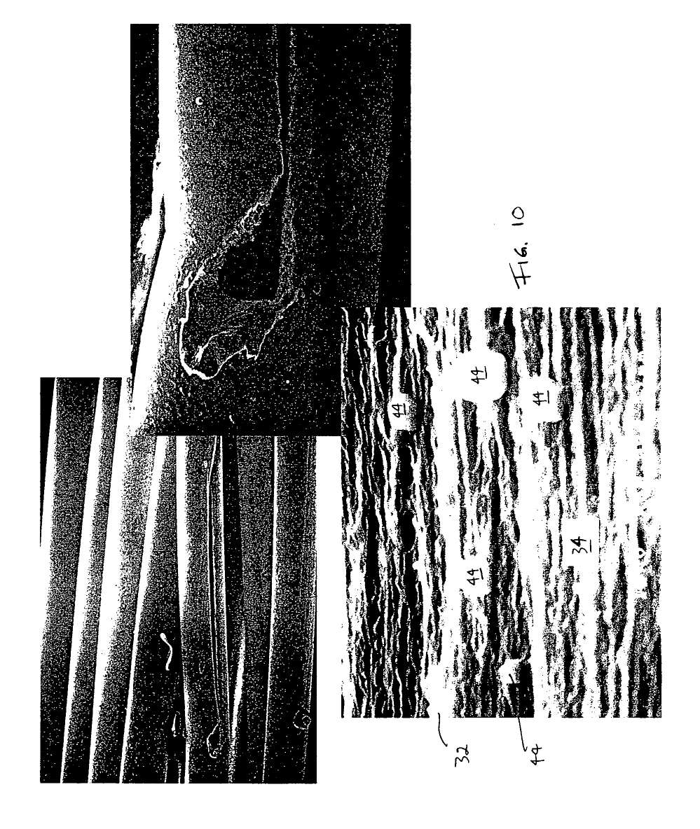

The size of the salt particles created in an embodiment is between thirty nanometers and two microns. The vast majority are too big to pass through the pores at the inner surface 34 of the wall 32. The smallest particles, however, may be able to pass through the largest pores of the fibers 30, as does the compressed air of fluid. The air and certain particles flow through the pores of the fibers 30 and through solenoids 156 and 158 to particle counter 160. As illustrated below in FIGS. 9A and 9B, a non-leaking filter yields a small particle count, whereas a leaking filter yields a much larger count.

The arrangement of solenoids provides a multitude of selectable flow paths. The flow paths can be used to detect leaks in particular areas of the bundle of fibers 30 within housing 12 of dialyzer 10. As illustrated, nine different flow paths exist. A first flow path exists between solenoid 152 and solenoid 156, wherein solenoids 154 and 158 are closed. This flow path is very useful for detecting leaks at one side of the dialyzer, near one of the potted ends 14 or 16 where many of the leaks occur typically. A second mirror image flow path exists between solenoids 154 and 158, wherein solenoids 152 and 156 are closed. This flow path is very useful for testing the integrity of the fibers 30 at the opposing potted end.

A third flow path exists between solenoid 152 and solenoid 158, wherein solenoids 154 and 156 are closed. A fourth flow path exists between solenoid 152 and solenoids 156 and 158, wherein solenoid 154 is closed. A fifth flow path exists between solenoid 154 and 156, wherein solenoids 152 and 158 are closed. A sixth flow path exists between solenoid 154 and solenoids 156 and 158, wherein solenoid 152 is closed. Each of these four flow paths can be used to test leaks at the middle portion of dialyzer 10 (fourth and sixth paths also good for testing respective dialyzer ends).

Three more flow paths exist where the flow passes through both solenoids 152 and 154 to solenoid 156, solenoid 158 or both, yielding nine total flow paths. It should therefore be appreciated that the dialyzer 10 can be tested using the dry aerosol of the present invention from multiple directions. The test can be controlled to analyze selectively a certain portion of the dialyzer 10. In one embodiment, the solenoids are connected to a micro-controller or programmable logic controller that sequences the opening of the solenoids to test any one or more of the nine different flow paths in an embodiment. In an embodiment, two or three flow paths are selected to test each area of the fiber bundles sufficiently and quickly.

As discussed above, multiple dialyzers 10 may be tested simultaneously, wherein any of the possible sequences is run simultaneously on multiple dialyzers. In the illustrated embodiment, each dialyzer outputs to a separate test CNC 160. In an alternative embodiment, at least two dialyzers 10 output to the same test CNC 160, wherein the micro-controller sequences the flow to, for example, dialyzer 1 then dialyzer 2. Cost versus response time is balanced to produce an economical and time efficient test.

As discussed above, the wet test takes several minutes to prepare, test and dry the dialyzers. The test of the present invention can determine accurately a leaking fiber bundle in seconds. In various tests performed in the laboratory configuration of FIGS. 7 and 8, leaks were determined in two to ten seconds. The system 100 and method of using same provide a significant advantage over the wet test. Also, when multiple sequences are used, it is possible to determine which sequence resulted in a leak and therefore narrow down the area of the dialyzer 10 that is leaking. It is possible to repair a leaking dialyzer and return it to service. The system and method of the present invention enable dialyzer repair and results that are at least as accurate as the wet test.

The system 100 allows the particle size and concentration to be varied using different concentrations of particle matter in solution 115 as well as by varying the pressure via regulator 104 and flowrate via a valve, such as a needle valve provided with flow meter 108. Any salt particles that escape the walls 32 of the dialyzer 30 are of a size that can be counted by CNC 160. The varying particle sizes of the polydisperse stream provide the ability to test for different size leaks, per ISO 14644-1 or IEST 209-E, which require different test intervals for different sizes of leaks. Smaller leaks require typically longer test intervals. Desired particle sizes are created to test for different size leaks in different hollow fibers 30 used in different applications. The system 100 can also be used to test for different size leaks within the same hollow fiber 30. While the size of the particle is relevant to the size of the leak, the size of the particle entering the dialyzer 10 is irrelevant to counters 150 and 160 because counters 150 and 160 grow the particle to an easily detectable size using alcohol condensation as described above.

Referring now to FIGS. 9A and 9B, two sections of a hollow fiber 30 are illustrated. Hollow fiber 30 is defined by wall 32. Wall 32 has an inner surface 34. FIG. 9A illustrates that a non-leaking filter allows a small amount of particles to pass through wall 32 and be counted by counter 160. FIG. 9B illustrates that wall 32 for a myriad of reasons has developed a tear 42. It has been observed that a tear or leak in the wall of hollow fiber 30 yields particle counts that exceed the normal count by orders of magnitude as indicated by counter 160 of FIG. 9B with respect to the count of counter 160 of FIG. 9A.

It has also been observed that the presence of a leak is detected virtually immediately. That is, when a known leaking dialyzer has been tested, wherein the leak exists on one side of the dialyzer, when the sequence switches from the non-leaking side to the leaking side of the dialyzer, the count jumps virtually instantaneously. The system and method of the present invention therefore appear to provide a very accurate, quick and safe alternative to the wet test.

Referring now to FIG. 10, a magnified view of the inner surface 34 of a section of wall 32 shows the residual salt particles 44 that are left after the testing method of the present invention is completed. Tests performed have shown that the total mass of sodium chloride remaining inside dialyzer 10 after the test is in the picogram (10⁻¹² gram) range. This small remaining amount of salt nanospheres is safe physiologically for the patient.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A system for detecting leaks in a dialyzer, the dialyzer including a bundle of hollow fibers with walls having pores, the system comprising:
a device for injecting variously sized physiologically safe particles into a lumen of each of at least a majority of the fibers, wherein at least a majority of the particles are too large to pass through a majority of the pores of the walls; and
a particle counter that counts particles that escape through the fiber walls.

2. The system of claim 1, which includes a pressurized fluid, wherein the device combines the variously sized particles with the fluid.

3. The system of claim 1, wherein the pressurized fluid includes pressurized air.

4. The system of claim 1, wherein the particles are NaCl.

5. The system of claim 1, which includes a liquid initially entraining the particles.

6. The system of claim 1, wherein the device includes an atomizer.

7. The system of claim 1, which includes at least one device for removing vapor from the particles before the particles enter the dialyzer.

8. The system of claim 7, wherein the moisture removing device is selected from the group consisting of: a heater and a chemical drying device.

9. The system of claim 1, which includes a device for neutralizing electrically the particles before the particles enter the dialyzer.

10. The system of claim 1, which includes a mixing chamber that mixes the particles and the fluid before the particles enter the dialyzer.

11. The system of claim 10, which includes a plurality of dialyzers in communication with the mixing chamber.

12. The system of claim 1, wherein the counter communicates with a plurality of dialyzers.

13. The system of claim 1, which includes a plurality of particle counters in communication with the plurality of dialyzers.

14. The system of claim 1, which includes a flow splitter that splits the flow of particles and fluid before the particles enter the dialyzer.

15. The system of claim 14, wherein the counter is a first counter and is in communication with a first path of the split flow, and which includes a second counter that in is communication with a second path of the split flow, the second path not connected to the dialyzer.

16. The system of claim 15, which includes a microprocessor that inputs an amount of particles counted by the first and second counters.

17. The system of claim 1, which includes a plurality of the devices operating in parallel.

18. The system of claim 1, which includes a diffuser operable with the dialyzer that disperses the particles so that the particles enter the hollow fibers more evenly.

19. The system of claim 1, wherein the particles are introduced into the hollow fibers at a plurality of locations on the dialyzer.

20. The system of claim 1, which includes a plurality of flow lines extending from the dialyzer to the particle counter.

21. The system of claim 1, which includes a sequence in which flow of the fluid and particles is switched from a first flow path through the dialyzer to a second flow path through the dialyzer, wherein particles flowing through the first and second paths are counted.

22. A system for detecting leaks in a dialyzer including a bundle of hollow fibers having porous walls, the system comprising:
a solution including physiologically safe particles;
a device that creates an aerosol from the solution; and
wherein the aerosol is injected inside the hollow fibers and a particle counter counts particles flowing through at least one of the fiber walls.

23. The system of claim 22, wherein the solution includes from about 0.001 to about 99% percent salt in water.

24. The system of claim 22, wherein the particles are about thirty nanometers to about two microns in size.

25. The system of claim 22, which includes a heater that blows heated air into a mixing chamber with the aerosol.

26. The system of claim 22, wherein the hollow fibers have inner surfaces defining pore openings of about five nanometers to about one hundred nanometers.

27. The system of claim 22, wherein the particle counter is a condensation nucleus counter.

28. The system of claim 22, wherein at least one of a plurality of blood receiving/discharging ends of the dialyzer serves as an inlet for the aerosol and at least one of a plurality of dialysate ports serves as an outlet for at least vapor of the aerosol to escape from the hollow fibers.

29. The system of claim 28, which includes a plurality of flow control devices in communication with the blood ends and the dialysate ports, the flow control devices providing a plurality of selectable flow paths through the dialyzer.

30. A method of testing a dialyzer for leaks comprising the steps of:
(a) creating an aerosol having physiologically safe polydisperse particles;
(b) forcing the aerosol into hollow fiber walls bundled in the dialyzer; and
(c) rejecting the dialyzer if at least a threshold amount of particles escape through the fiber walls.

31. The method of claim 30, which includes the step of pressurizing the aerosol.

32. The method of claim 30, which includes the step of drying the aerosol.

33. The method of claim 32, wherein drying the aerosol includes mixing the aerosol with heated air.

34. The method of claim 30, which includes the step of removing static electrical charge from the aerosol.

35. The method of claim 30, which includes the step of adjusting the pressurization of the aerosol to adjust a time needed to determine if the threshold amount has been reached.

36. The method of claim 30, which includes the step of adjusting at least one of a concentration of particles formed in the aerosol and a pressure of the aerosol to adjust for a number of dialyzers connected operably to the pressurized aerosol.

37. The method of claim 30, which includes creating multiple aerosol streams to adjust for a number of dialyzers connected operably to the pressurized aerosol.

38. The method of claim 30, which includes the step of condensing alcohol onto particles that have passed through the fiber walls and counting the condensated particles to determine if the threshold amount has been reached.

39. The method of claim 30, which includes the step of splitting the pressurized aerosol into multiple flow paths and determining if the testing is functioning properly by counting particles in one of the split paths.

40. The method of claim 30, wherein the threshold amount of particles is based on a number of particles that pass through the fiber walls of a non-leaking dialyzer.

41. A method of testing a dialyzer for leaks comprising the steps of:
(a) varying a concentration of a particle producing matter in a liquid to vary sizes of particles produced when entraining the matter and liquid in a gas stream;
(b) removing the liquid from the gas stream;
(c) flowing the gas and particles into hollow fibers bundled in the dialyzer; and
(d) counting particles that escape from the fibers.

42. The method of claim 41, wherein increasing the concentration increases the size of the particles.

43. The method of claim 41, wherein a given concentration yields multiple sizes of particles.

44. The method of claim 41, which includes the step of selecting the concentration to produce particles of a size that operates suitably with a pore size of pores defined by the hollow fibers.

45. The method of claim 41, wherein the matter is sodium chloride, the liquid is water and the gas is air.

46. A method of testing leaks in a dialyzer having a housing, the housing having first and second potted ends, first and second dialysate ports, the first port located near the first end and the second port located near the second end, a bundle of hollow, porous fibers having fiber walls placed inside the housing fibers so that ends of the fibers extend through the potted ends, and wherein blood flows within the fiber walls and dialysate flows inside the housing and outside the fiber walls, the method including the steps of:
at the first end, flowing particles entrained in a gas to pass within the fiber walls and flowing at least the gas across the fiber walls and out the first port to test the fibers near the first end of the housing; and
at the second end, flowing particles and gas within the fiber walls and flowing at least the gas across the fiber walls and out the second port to test the fibers near the second end of the housing.

47. The method of claim 46, which includes the step of flowing at the first end particles and gas within the fiber walls and flowing at least the gas across fiber walls and out the second port to test the fibers near the middle of the housing.

48. The method of claim 46, which includes the step of flowing particles and gas within the fiber walls at both the first and second ends of the housing and flowing at least the gas across fiber walls and out the second port.

49. The method of claim 46, which includes the step of flowing particles and gas within the fibers at both the first and second ends of the housing and flowing at least the gas across fiber walls and out the first and second ports.

50. A method of testing for leaks in a dialyzer comprising the steps of:
(a) varying a concentration of a particle producing matter in a liquid to vary sizes of particles produced when entraining the matter and liquid in a gas stream;
(b) flowing the gas and particles into hollow fibers bundled in the dialyzer;
(c) adding to a size the of particles; and
(d) counting particles that escape from the fibers.

51. The method of claim 50, which includes the step of drying the particles before enlarging the particles.

52. The method of claim 50, wherein adding to the size of the particles includes condensing a liquid onto the particles.
